(19) United States
(12) Patent Application Publication
(10) Pub. No.: US 2019/0170898 A1
(43) Pub. Date: Jun. 6, 2019

(54) Systems and Methods for Real-Time Data Quality Analysis in Drilling Rigs

(71) Applicant: Saudi Arabian Oil Company, Dhahran (SA)

(72) Inventors: William B. Contreras Otalvora, Dhahran (SA); Lenin S. Juarez Pineda, Dhahran (SA)

(21) Appl. No.: 15/832,297

(22) Filed: Dec. 5, 2017

(51) Int. Cl. G01V 11/00; E21B 47/00; E21B 47/06; E21B 47/04

(52) U.S. Cl. CPC G01V 11/002; E21B 47/00; E21B 44/02; E21B 47/04; E21B 47/06

(57) ABSTRACT

Software-based quality control analysis of rig sensor data. At least some of the various embodiments are computer-readable mediums storing a program that, when executed by a processor, causes the processor to read rig sensor data from a hydrocarbon well, and perform a quality control analysis on the rig sensor data.

### TECHNICAL FIELD

Example embodiments relate to a software-based quality analysis of drilling rig sensor data. At least some of the various embodiments are computer-readable mediums storing a program that, when executed by a processor, causes the processor to read sensor data from a hydrocarbon well drilling rig, and perform quality analysis on the drilling rig sensor data.

### BACKGROUND

Drilling rigs in general include a number of sensors and devices to measure, monitor and detect a variety of conditions in the wellbore, including, but not limited to, torque, bit depth, hole depth, pump pressure, and the like. This data is usually generated in real-time, but can be enormous, and too voluminous for personnel at the drilling site to review and interpret in sufficient detail and time to affect the drilling operation. Some of the monitored data may be transmitted back to an engineer or geologist at a remote site, but the amount of data transmitted may be limited due to bandwidth limitations. Thus, not only is there a delay in processing due to transmission time, the processing and analysis of the data may be inaccurate due to missing or incomplete data. Drilling related operations continue, however, even while awaiting the results of analysis.

A real-time drilling monitor (RTDM) workstation is sometimes used in such arrangements, where a RTDM receives sensor signals from a plurality of sensors and generates single graphical user interface with dynamically generated parameters based on the sensor signals. Similarly, an intelligent drilling advisor system may also be used where the advisor may include an information integration environment that accesses and configures software agents that acquire data from sensors at a drilling site, transmit that data to the information integration environment, and drive the drilling state and the drilling recommendations for drilling operations at the drilling site. However, the restricted quality of rig sensor data due to limited sensor precision or sensor failures poses a crucial problem, which is very often ignored by data managers and drilling engineers at the well site. If not handled carefully, these data quality deficiencies may result in misguided or even incorrect decisions.

### SUMMARY

Accordingly, one example embodiment relates to a system for monitoring sensor data quality in a drilling rig in real time. The system includes one or more sensors operably connected to one or more components of the drilling rig, the one or more sensors configured to generate sensor data and transmit the sensor data to a control unit, one or more processors operatively coupled to the control unit, and a non-transitory computer-readable medium in communication with the one or more processors and having stored thereon a set of instructions that when executed cause the one or more processors to perform operations including receiving rig sensor data from the one or more components of the drilling rig, determining a level of completeness of the sensor data by measuring a degree to which the sensor data may include one or more desired parameters, determining a level of uniformity of the sensor data by measuring a degree to which the sensor data is uniform over a predetermined period of time, determining a level of sensibility of the sensor data by measuring a degree to which the sensor data falls within a set of predetermined logic boundaries, determining a resolution of the sensor data by measuring a frequency with which the sensor data matches an expected sensor data, determining a structure of the sensor data by measuring a degree to which the sensor data complies with a wellsite information transfer standard, determining a format of the sensor data by measuring a degree to which the sensor data complies with a wellsite information transfer standard markup language, applying a structured logic to the sensor data, and determining a data quality index based on a weighted average of the level of completeness, the level of uniformity, the level of sensibility, the resolution, the structure, and the format of the sensor data.

The instructions may further cause the one or more processors to perform operations including receiving the data quality index from analysis of the rig sensor data, and generating a graphical illustration displaying data issues in the received rig sensor data. In one example embodiment, the weighted average may include 40% completeness, 20% uniformity, 20% sensibility, 10% resolution, 5% structure, and 5% format. The instructions also cause the one or more processors to perform operations including determining a number of rigs within a predetermined range of data quality indices, and generating a graphical illustration displaying the number of rigs against the data quality indices. The one or more sensors may include sensors that detect torque, revolutions per minute (RPM), weight on bit (WOB), hook load (HL), stand pipe pressure (SPP), pump pressure, hole depth, or bit depth. Determining a level of completeness of the sensor data may further include determining a number of streamed or received records and comparing the number to a number of expected records. Determining a level of uniformity of the sensor data may further include determining a number of records that are separated by a time interval greater than or less than a predetermined time interval. Determining a level of sensibility of the sensor data may further include determining a number of records that are outside of the predetermined logic boundaries. Determining a resolution of the sensor data may further include determining a number of records received or streamed within a predetermined period of time.

Another example embodiment is a method for monitoring sensor data quality in a drilling rig in real time. The method may include receiving, by one or more processors coupled to a control unit in the drilling rig, rig sensor data from one or more components of the drilling rig, determining a level of completeness of the sensor data by measuring a degree to which the sensor data may include one or more desired parameters, determining a level of uniformity of the sensor data by measuring a degree to which the sensor data is uniform over a predetermined period of time, determining a level of sensibility of the sensor data by measuring a degree to which the sensor data falls within a set of predetermined logic boundaries, determining a resolution of the sensor data by measuring a frequency with which the sensor data matches an expected sensor data, determining a structure of the sensor data by measuring a degree to which the sensor data complies with a wellsite information transfer standard, determining a format of the sensor data by measuring a degree to which the sensor data complies with a wellsite information transfer standard markup language, applying a structured logic to the sensor data and determining a data quality index based on a weighted average of the level of completeness, the level of uniformity, the level of sensibility, the resolution, the structure, and the format of the sensor data. The method may also include receiving, by the one or more processors, the data quality index from analysis of the rig sensor data, and generating a graphical illustration displaying data issues in the received rig sensor data.

Another example embodiment is a non-transitory computer-readable medium including instructions stored thereon, which when executed by one or more processors operatively coupled to the computer-readable medium, cause the one or more processors to perform operations including receiving rig sensor data from one or more components of a drilling rig, determining a level of completeness of sensor data acquired from a control unit of an oil rig by measuring a degree to which the sensor data may include one or more desired parameters, determining a level of uniformity of the sensor data by measuring a degree to which the sensor data is uniform over a predetermined period of time, determining a level of sensibility of the sensor data by measuring a degree to which the sensor data falls within a set of predetermined logic boundaries, determining a resolution of the sensor data by measuring a frequency with which the sensor data matches an expected sensor data, determining a structure of the sensor data by measuring a degree to which the sensor data complies with a wellsite information transfer standard, determining a format of the sensor data by measuring a degree to which the sensor data complies with a wellsite information transfer standard markup language, applying a structured logic to the sensor data, and determining a data quality index based on a weighted average of the level of completeness, the level of uniformity, the level of sensibility, the resolution, the structure, and the format of the sensor data.

The instructions may further cause the one or more processors to perform operations including receiving the data quality index from analysis of the rig sensor data, and generating a graphical illustration displaying data issues in the received rig sensor data. The weighted average may include 40% completeness, 20% uniformity, 20% sensibility, 10% resolution, 5% structure, and 5% format. The instructions may further cause the one or more processors to perform operations including determining a number of rigs within a predetermined range of data quality indices, and generating a graphical illustration displaying the number of rigs against the data quality indices. The one or more sensors may include sensors that detect torque, revolutions per minute (RPM), weight on bit (WOB), hook load (HL), stand pipe pressure (SPP), pump pressure, hole depth, or bit depth. Determining a level of completeness of the sensor data may further include determining a number of streamed or received records and comparing the number to a number of expected records. Determining a level of uniformity of the sensor data may further include determining a number of records that are separated by a time interval greater than or less than a predetermined time interval. Determining a level of sensibility of the sensor data may further include determining a number of records that are outside of the predetermined logic boundaries. Determining a resolution of the sensor data may further include determining a number of records received or streamed within a predetermined period of time.

### BRIEF DESCRIPTION OF THE DRAWINGS

So that the manner in which the features, advantages and objects of the invention, as well as others which may become apparent, are attained and can be understood in more detail, more particular description of the invention briefly summarized above may be had by reference to the embodiment thereof which is illustrated in the appended drawings, which drawings form a part of this specification. It is to be noted, however, that the drawings illustrate only example embodiments of the invention and is therefore not to be considered limiting of its scope as the invention may admit to other equally effective embodiments.

FIG. 1 is a block diagram showing an embodiment of a data quality analyses system, according to one or more example embodiments of the disclosure.

FIG. 2 illustrates example operations in an example method for performing data quality analysis, according to one or more example embodiments of the disclosure.

FIG. 3 illustrates example operations in an example method for performing data quality analysis, according to one or more example embodiments of the disclosure.

FIG. 4 illustrates a table showing data that may be collected, streamed, or otherwise received from a drilling rig, according to one or more example embodiments of the disclosure.

FIG. 5 illustrates an example algorithm or method executed by the system for performing data analysis on rig sensor data, according to one or more example embodiments of the disclosure.

FIG. 6 illustrates an example algorithm or method executed by the system for performing data analysis on rig sensor data, according to one or more example embodiments of the disclosure.

FIG. 7 illustrates an example chart generated by a system, according to one or more example embodiments of the disclosure.

FIG. 8 illustrates an example chart generated by a system, according to one or more example embodiments of the disclosure.

### DETAILED DESCRIPTION

The methods and systems of the present disclosure will now be described more fully hereinafter with reference to the accompanying drawings in which embodiments are shown. The methods and systems of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout.

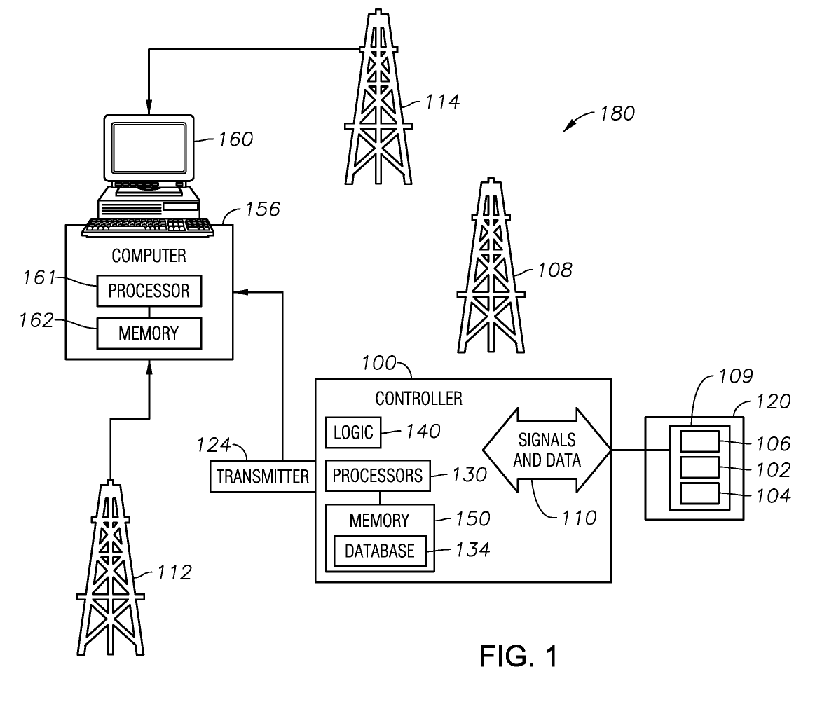

FIG. 1 is a block diagram showing a sensor data quality analyses system 180 in accordance with one or more example embodiments. In one example embodiment, the system 180 can include a combination of one or more measurement devices 109, and one or more controllers 100. Either one of the device 109 and/or the controller 100 can be located inside or outside of a device body 120 or attached to the outside of the device body 120 or coupled thereto. The device 109 may include one or more sensors or transducers 102 and one or more transmitters 104. The device 109 can further include one or more receivers 106. A controller 100 can be coupled to the device 109 for controlling operation of the device 109 (e.g., transmission of signals) as well as retrieving data from the device 109. The sensors 102 may include sensors that detect torque, revolutions per minute (RPM), weight on bit (WOB), hook load (HL), stand pipe pressure (SPP), pump pressure, hole depth, or bit depth. The data can include sensor data that may be categorized into one or more log families. The system 180 of FIG. 1 is for purposes of illustration only as device 109 can have different quantities of transducers/receivers, different devices can be used in the system, and/or the system can incorporate different controllers 100 depending on the type of device implemented.

The controller 100 may include a programmable drive and/or sampling control system. The controller can include logic 140 for acquiring sensor data and/or signals 110 from the device 109. Memory 150, located inside or outside the device body 120, can be used to store acquired data, and/or processing results (e.g., in a database 134). The memory 150 is communicatively coupled to the processor(s) 130. While not shown in FIG. 1, it should be noted that the memory 150 may be located above the surface of the geological formation. A data transmitter 124 may be used to transmit data for display by the sensor data quality analyses system. Thus, the system 180 may include the data transmitter 124 to transmit the data to a surface data processing computer 156.

The system can further include a computer 156 coupled to and configured to communicate with, control, and/or display data received from the controller 100. The computer 156 can include a processor 161 and memory 162 for controlling the system. A monitor 160 can be coupled to the computer for displaying data that can include sensor data, transformed (e.g., filtered) sensor data, and/or quality control data. The computer 156 can be configured to execute the various methods for collection and display of elected sensor data for integrated quality control.

As illustrated in FIG. 1, computer 156 may be connected to a plurality of drilling rigs 108, 112, 114 to collect and analyze rig sensor data from a plurality of devices 120 that may be installed on the plurality of drilling rigs 108, 112, 114. The system 180 may be accessed through one or more workstations, or other computing devices 156. A workstation comprises one or more computers or computing devices, and may be located at a well site or remotely. The system 180 can be implemented on a single computer system, multiple computers, a computer server, a handheld computing device, a tablet computing device, a smart phone, or any other type of computing device.

The system 180 may be in communication with and receive input from various sensors. In general, the system 180 collects real-time sensor data sampled during operations at the well site. The system processes the data, and provides nearly instantaneous numerical and visual feedback through a variety of graphical user interfaces (“GUIs”).

The GUIs are populated with dynamically updated information, static information, and risk assessments, although they also may be populated with other types of information. The users of the system thus are able to view and understand a substantial amount of information about the status of the particular well site operation in a single view, with the ability to obtain more detailed information in a series of additional views.

In one embodiment, the system 180 is installed at the well site, and thus reduces the need to transmit date to a remote site for processing. The well site can be an offshore drilling platform or land-based drilling rig. This reduces delays due to transmitting information to a remote site for processing, then transmitting the results of that processing back to the well site. It also reduces potential inaccuracies in the analysis due to the reduction in the data being transmitted. The system thus allows personnel at the well site to monitor the well site operation in real time, and respond to changes or uncertainties encountered during the operation. The response may include comparing the real time data to the current well plan, and modifying the well plan. In yet another embodiment, the system is installed at a remote site, in addition to the well site. This permits users at the remote site to monitor the well-site operation in a similar manner to a user at the well-site installation.

In some exemplary embodiments, the system is a web-enabled application, and the system software may be accessed over a network connection such as the Internet. A user can access the software via the user's web browser. In some embodiments, the system performs all of the computations and processing described herein and only display data is transmitted to the remote browser or client for rendering screen displays on the remote computer. In another embodiment, the remote browser or software on the remote system performs some of the functionality described herein.

Sensors may be connected directly to the workstation at the well site, or through one or more intermediate devices, such as switches, networks, or the like. Sensors may include, but are not limited to, sensors that detect torque, revolutions per minute (RPM), and weight on bit (WOB). These surface sensors are sampled by the system during drilling or well site operations to provide information about a number of parameters. Surface-related parameters include, but are not limited to, the following: block position; block height; trip/running speed; bit depth; hole depth; lag depth; gas total; weight on bit; hook load; choke pressure; stand pipe pressure; surface torque; surface rotary; mud motor speed; flow in; flow out; mud weight; rate of penetration; pump rate; cumulative stroke count; active mud system total; active mud system change; all trip tanks; and mud temperature (in and out). Based on the sensed parameters, the system causes the processors or microprocessor to calculate a variety of other parameters, as described below.

In several embodiments, the system software comprises a database/server, a display or visualization module, one or more smart agents, one or more templates, and one or more “widgets.” The database/server aggregates, distributes and manages real-time data being generated on the rig and received through the sensors. The display or visualization module implements a variety of GUI displays, referred to herein as “consoles,” for a variety of well site operations. The information shown on a console may comprise raw data and calculated data in real time.

Templates defining a visual layout may be selected or created by a user to display information in some portions of or all of a console. In some embodiments, a template comprises an XML file. A template can be populated with a variety of information, including, but not limited to, raw sensor data, processed sensor data, calculated data values, and other information, graphs, and text. Some information may be static, while other information is dynamically updated in real time during the well site operation. In one embodiment, a template may be built by combining one or more display “widgets” which present data or other information. Smart agents perform calculations based on data generated through or by one or more sensors, and said calculated data can then be displayed by a corresponding display widgets.

In one exemplary embodiment, the system provides the user the option to implement a number of consoles corresponding to particular well site operations. In one embodiment, consoles include, but are not limited to, rig-site fluid management, BOP management, cementing, and casing running. A variety of smart agents and other programs are used by the consoles. Smart agents and other programs may be designed for use by a particular console, or may be used by multiple consoles. A particular installation of the system may comprise a single console, a sub-set of available consoles, or all available consoles.

Agents can be configured, and configuration files created or modified, using the agent properties display. The same properties are used for each agent, whether the agent configuration is created or imported. The specific configuration information (including, but not limited to, parameters, tables, inputs, and outputs) varies depending on the smart agent. Parameters represent the overall configuration of the agent, and include basic settings including, but not limited to, start and stop parameters, tracing, whether data is read to a log, and other basic agent information. Tables comprise information appearing in database tables associated with the agent. Inputs and outputs are the input or output mnemonics that are being tracked or reported on by the agent. For several embodiments, in order for data to be tracked or reported on, each output must have an associated output. This includes, but is not limited to, log and curve information.

In one embodiment, the system allows for the easy monitoring and evaluation in real time of the quality of various data streams generated during well-site drilling and production operations, and it can be configured to provide a variety of visible and audible signals to enable users to judge the quality and trustworthiness of the data being displayed in the various consoles. Particular data quality tests can be configured for selected data streams, and these tests can be applied to (i.e., subscribe to) the appropriate data streams (or curves) through the various consoles. The system can, for example, provide a visual data quality indicator together with the actual drilling or production data, in real time. The system further has the ability to configure a number of data quality monitors running at a number of rigs or well sites by providing a centralized management tool at a central location.

A variety of icons may be shown on the consoles to indicate data quality status. In one embodiment, the data quality indicator is based on the dynamic evaluation of data quality for a period of time. In one particular embodiment, the indicator is based on the last 30 minutes of data. In several exemplary embodiments, a data quality widget aggregates the status of all subscribed curve tests and displays this as a single icon. A logic progression is used to create an aggregated status icon based on a set of curve or data set tests (which can be accessed via a data quality dashboard, as described below), where there is full or substantially full subscription in the data quality widget to the tests. It may also be used to create an aggregated status icon where there is not full subscription (e.g., a “not monitoring” status for at least one of the curves or data sets).

Some example embodiments relate to systems, methods, and computer programs for analyzing data quality of rig sensor data using a structured logic. The structured logic includes determining a plurality of parameters to compute a quality ranking for the rig sensor data. The combination of these parameters is used to calculate a data quality index for the data output by the drilling rig. The analysis of the data quality parameters allows identifying elements that may need to be improved during the drilling operations.

One example embodiment is a system 180 for monitoring sensor data quality in one or more drilling rigs 108, 112, 114 in real time, as shown in FIG. 1, for example. The system 180 includes one or more sensors 102 operably connected to one or more components 109 of the drilling rig 108. The one or more sensors 102 are configured to generate sensor data and transmit the sensor data to a control unit 100, 156. The system 180 also includes one or more processors 130, 161 operatively coupled to the control unit 100, 156, and a non-transitory computer-readable medium 150, 162 in communication with the one or more processors 130, 161 and having stored thereon a set of instructions that when executed cause the one or more processors 130, 161 to perform operations including receiving rig sensor data from the one or more components 109 of the drilling rig 108, determining a level of completeness of the sensor data by measuring a degree to which the sensor data may include one or more desired parameters, determining a level of uniformity of the sensor data by measuring a degree to which the sensor data is uniform over a predetermined period of time, determining a level of sensibility of the sensor data by measuring a degree to which the sensor data falls within a set of predetermined logic boundaries, determining a resolution of the sensor data by measuring a frequency with which the sensor data matches an expected sensor data, determining a structure of the sensor data by measuring a degree to which the sensor data complies with a wellsite information transfer standard, determining a format of the sensor data by measuring a degree to which the sensor data complies with a wellsite information transfer standard markup language, applying a structured logic to the sensor data, and determining a data quality index based on a weighted average of the level of completeness, the level of uniformity, the level of sensibility, the resolution, the structure, and the format of the sensor data.

The instructions may further cause the one or more processors 130, 161 to perform operations including receiving the data quality index from analysis of the rig sensor data, and generating a graphical illustration displaying, on a display device 160, data issues in the received rig sensor data. In one example embodiment, the weighted average may include 40% completeness, 20% uniformity, 20% sensibility, 10% resolution, 5% structure, and 5% format. The instructions also cause the one or more processors to perform operations including determining a number of rigs within a predetermined range of data quality indices, and generating a graphical illustration displaying the number of rigs against the data quality indices.

The one or more sensors may include sensors that detect torque, revolutions per minute (RPM), weight on bit (WOB), hook load (HL), stand pipe pressure (SPP), pump pressure, or bit depth. The surface sensors may be sampled by the system during drilling or well site operations to provide information about a plurality of parameters comprising block position; block height; trip/running speed; bit depth; hole depth; lag depth; weight on bit; hook load; stand pipe pressure; surface torque; surface rotary; mud motor speed; flow in; flow out; rate of penetration; pump rate; and cumulative stroke count.

The real time data quality index may be calculated based on a plurality of key performance indicators (KPIs). The KPIs may include, for example, completeness of data, which may be determined by measuring a degree to which the streamed records contain all required critical parameters. In some embodiments, the minimum parameters that the algorithm requires to run include RPM, WOB, Hookload, Block Position, Stand Pipe Pressure, Pump Pressure and Bit Depth. The KPIs may also include, for example, uniformity, which may be determined by measuring a degree to which the data stream is uniform over a period of time, including for example having an expected minimum sample rate. The KPIs may also include, for example, sensibility, which may be determined by measuring a degree to which the streamed records fall within a set of predetermined logic boundaries, for example between a higher threshold value and a lower threshold value. The KPIs may also include, for example, resolution, which may be determined by measuring a degree to which the frequency of streamed records match an expected value. The KPIs may also include, for example, structure, which may be determined by measuring a degree to which the data is in compliance with an industry standard, for example wellsite information transfer standard (WITS). The KPIs may also include, for example, format, which may be determined by measuring the readiness of the rig to stream data using a particular format, for example wellsite information transfer standard markup language (WITSML) format. Each of these KPIs may be assigned a certain percentage weight in order to calculate a data quality index for the rig sensor data. In other words the data quality index may be calculated based on a weighted average value of these KPIs. In one example embodiment, the assigned weights for each of the KPIs may be as follows: completeness (40%), uniformity (20%), sensibility (20%), resolution (10%), structure (5%), and format (5%). However, these percentages are purely exemplary and other percentages may also be used.

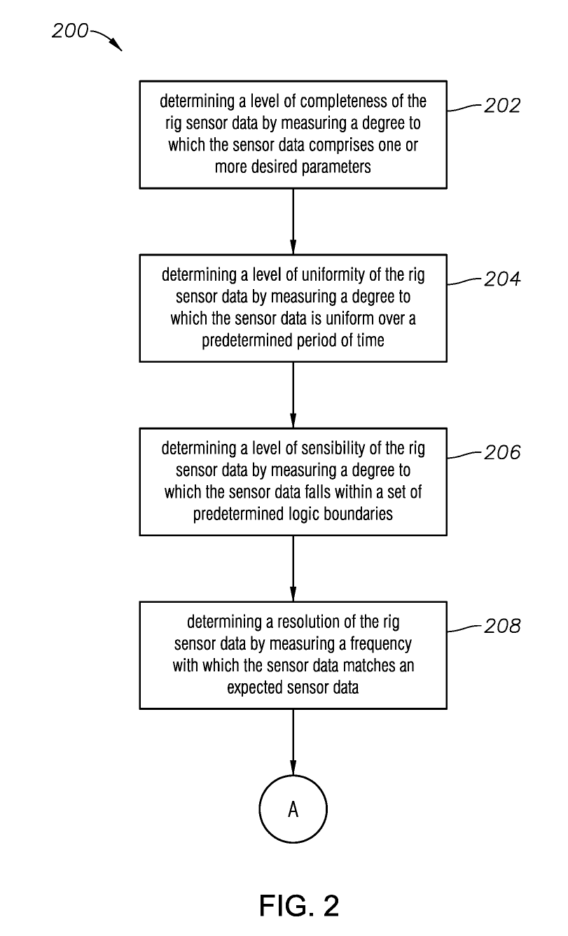

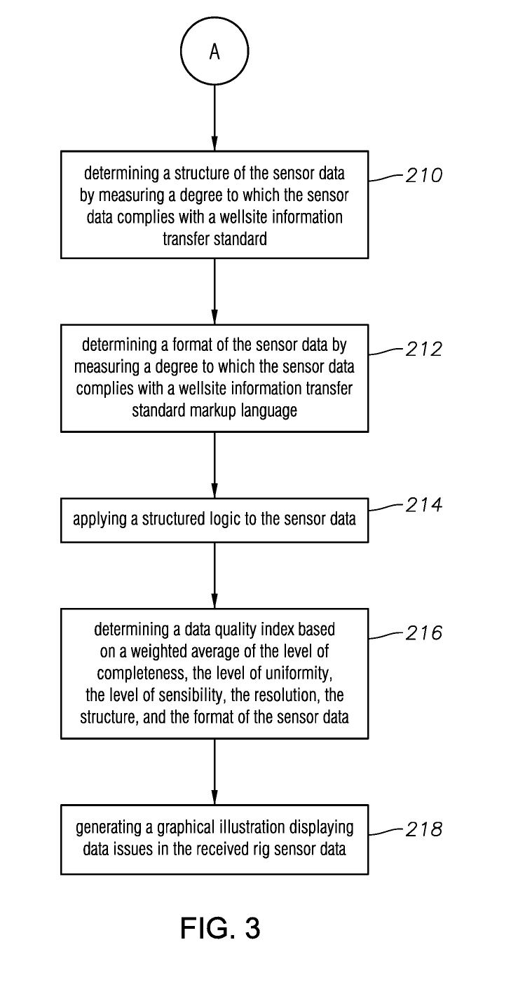

FIGS. 2 and 3 illustrate example steps involved in a method 200 for monitoring sensor data quality in a drilling rig in real time. The method may include receiving, by one or more processors coupled to a control unit in the drilling rig, rig sensor data from one or more components of the drilling rig. At step 202, the method may include determining a level of completeness of the sensor data by measuring a degree to which the sensor data may include one or more desired parameters. At step 204, the method may include determining a level of uniformity of the sensor data by measuring a degree to which the sensor data is uniform over a predetermined period of time. At step 206, the method may include determining a level of sensibility of the sensor data by measuring a degree to which the sensor data falls within a set of predetermined logic boundaries. At step 208, the method may include determining a resolution of the sensor data by measuring a frequency with which the sensor data matches an expected sensor data. Moving now to FIG. 3, at step 210, the method may include determining a structure of the sensor data by measuring a degree to which the sensor data complies with a wellsite information transfer standard. At step 212, the method may include determining a format of the sensor data by measuring a readiness of the oil rig to generate sensor data using a wellsite information transfer standard markup language. At step 214, the method may include applying a structured logic to the sensor data and at step 216, the method may include determining a data quality index based on a weighted average of the level of completeness, the level of uniformity, the level of sensibility, the resolution, the structure, and the format of the sensor data. The method may also include receiving, by the one or more processors, the data quality index from analysis of the rig sensor data, and generating a graphical illustration displaying data issues in the received rig sensor data, as illustrated in step 218.

In one example embodiment, the step of determining a level of completeness of the sensor data may further include determining a number of streamed or received records and comparing the number to a number of expected records. The step of determining a level of uniformity of the sensor data may further include determining a number of records that are separated by a time interval greater than or less than a predetermined time interval. The step of determining a level of sensibility of the sensor data may further include determining a number of records that are outside of the predetermined logic boundaries. The step of determining a resolution of the sensor data may further include determining a number of records received or streamed within a predetermined period of time.

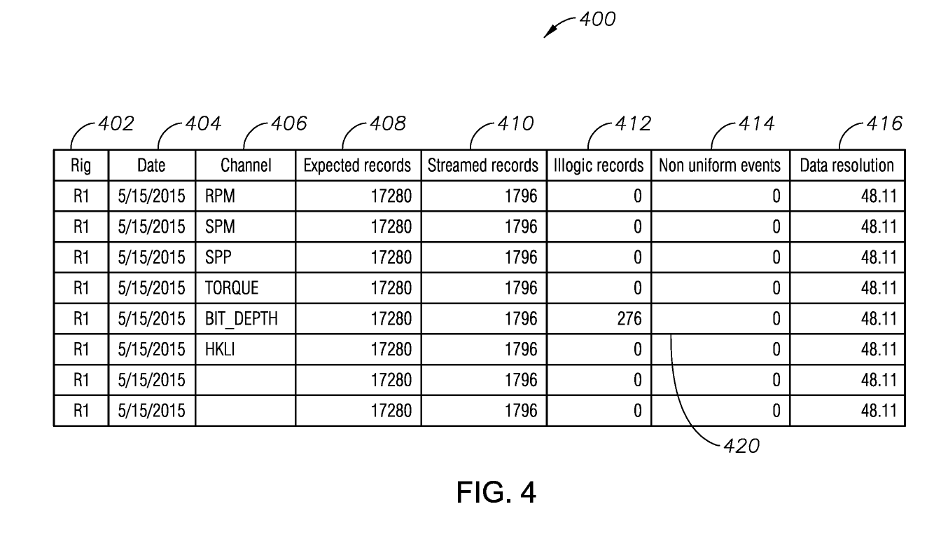

FIG. 4 illustrates an example table 400 showing data may be collected, streamed, or otherwise received from a drilling rig. In this example, the first column 402 indicates the rig number from which the rig sensor data was obtained. The second column 404 indicates the date on which the rig sensor data was obtained. The third column 406 indicates the channel from which the rig sensor data was obtained, for example, RPM, SPM, Torque, Bit Depth, HKLI, etc. The fourth column 408 may indicate the number of expected records for each of the channels in column 406. The fifth column 410 may indicate the number of streamed records for each of the channels in column 406. The sixth column 412 may indicate the number of illogical records within the number of streamed records in column 410. The seventh column 414 may indicate the number of non-uniform events, for example, data points that fall below a predefined data rate. The eighth column 416 may indicate the data resolution of the rig sensor data gathered for each of the channels in column 406.

In a data interpretation example illustrated in FIG. 4, highlighted area 402 shows data pertaining to a channel ‘bit depth’ in which 17,280 records were expected, however, only 1796 records were received. Of the 1796 streamed records, 276 were illogical records or out of predefined boundaries. However, since the 1796 records were received within a predetermined time interval of, for example, 5 seconds or less, the number of non-uniform events is recorded as zero ‘0’. The data resolution in this example channel was recorded as 48.11.

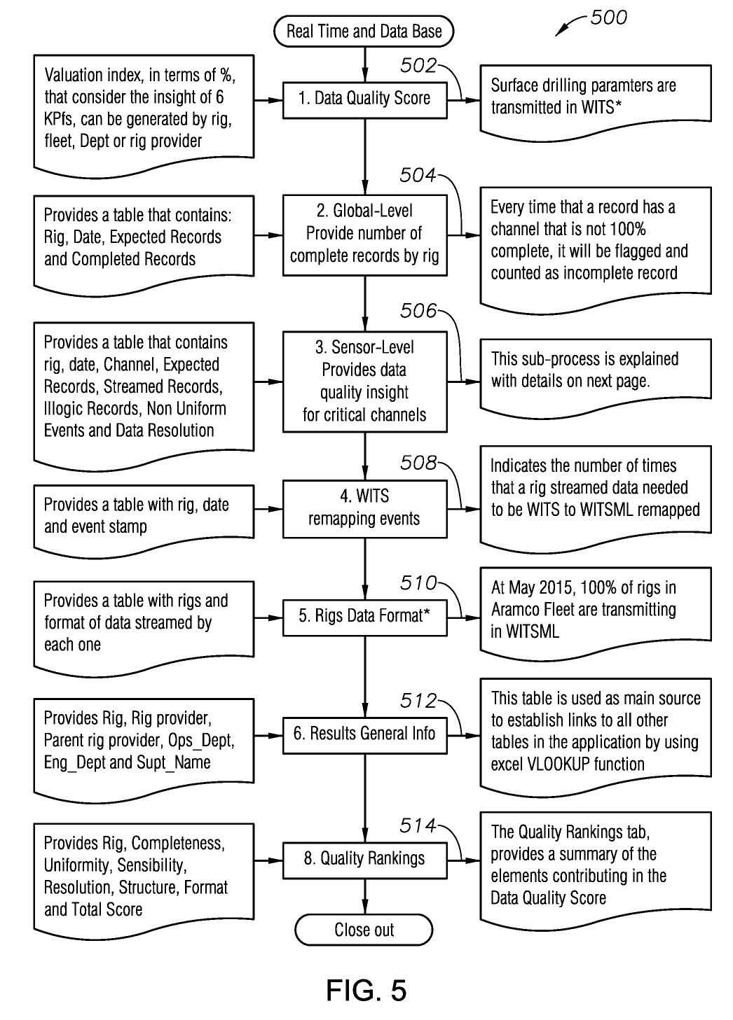

FIG. 5 illustrates an example algorithm or method 500 executed by the system for performing data analysis on the rig sensor data acquired. The algorithm may be divided into a plurality of logic sections, as illustrated in FIG. 5. At step 502, the overall data quality score for the subject data may be provided. The data quality score may include a valuation index in terms of a percentage that takes into account all six (6) KPIs discussed above, and can be generated by rig number, fleet number, department or rig provider. All the surface drilling parameters in this step may be submitted in wellsite information transfer standard. At step 504, the global-level data may be provided. For example, the global-level data may provide the number of complete records by rig number. This may be provided in the form of a table that includes, for example, rig number, date, expected records, and completed records. In this example, every time that a record has a channel that is not 100% complete, that channel may be flagged and counter as an incomplete record. At step 506, the system may provide sensor-level data including data quality insight for critical channels. In this example, the system may provide a table that includes, for example, rig number, date, channel, number of expected records, number of streamed records, number of illogical records, number of non-uniform events and data resolution of the date received. At step 508, the system may provide information on wellsite information transfer standard remapping events. For example, the system may provide a table with rig number, date, and event stamp. This may indicate the number of times that a rigs streamed data needed to be remapped from wellsite information transfer standard to wellsite information transfer standard markup language. At step 510, the system may provide the rigs data format by providing a table with rig numbers and data format of the data streamed by each one. For example, the system may be able to indicate that on a given date X% of rigs in a fleet were transmitting in wellsite information transfer standard markup language. At step 512, the system may provide general information about the overall results. For example, the system may provide rig number, rig provider, parent rig provider, department name and/or superintendent's name. This table may be used as a source to establish links to all other tables in the application by using, for example, the VLOOKUP function in Microsoft® Excel®. At step 514, the system may provide overall quality rankings by providing rig number, and values for completeness, uniformity, sensibility, resolution, structure, format, and total score for each of the rigs in the table. The quality rankings tab may also provide a summary of the elements contributing in the overall data quality score.

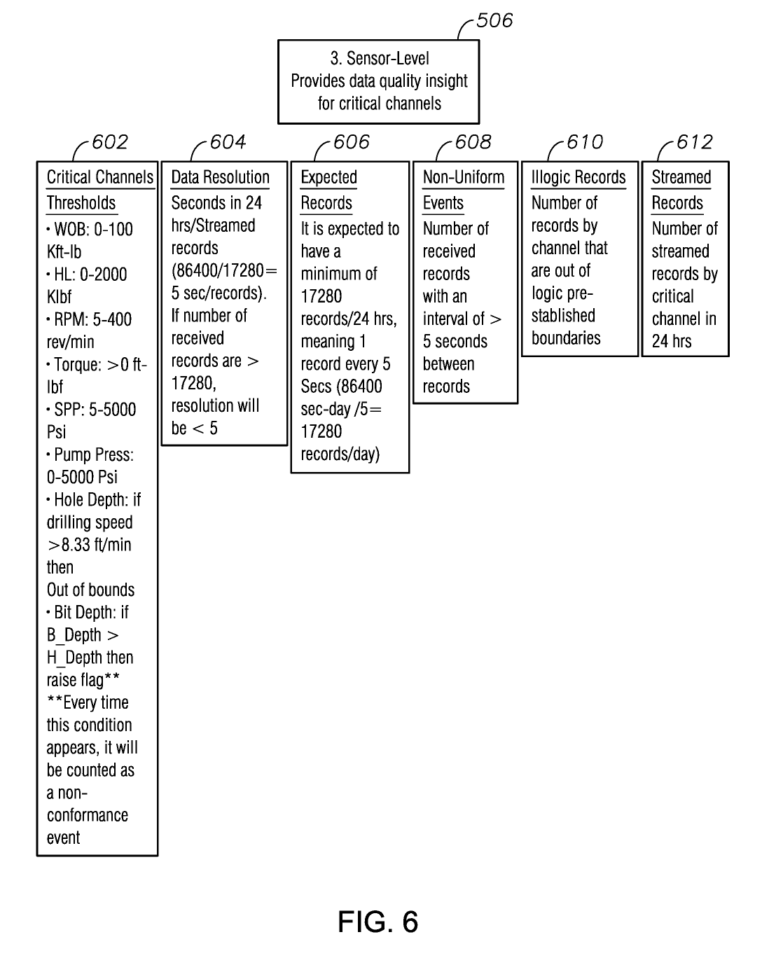

FIG. 6 illustrates step 506 (from FIG. 5) in further detail. In this example, the system may provide information about the rig sensor data, including for example, values for critical channel thresholds 602, expected minimum data resolution 604, expected minimum expected records 606, number of non-uniform events 608, number of illogic records 610, and number of streamed records 612. In one example embodiment, the critical channel thresholds 602 may be defined for different channels as follows. For example, for WOB the threshold may be defined as being between 0-100 Kft-lb, for HL the threshold may be defined as being between 0-2000 Klbf, for RPM the threshold may be defined as being between 5-400 rev/min, for Torque the threshold may be defined as being greater than 0 ft-lbf, for SPP the threshold may be defined as being between 5-5000 Psi, for Pump Press the threshold may be defined as being between 0-5000 Psi, for hole depth if the drilling speed is greater than 8.33 ft/min then the hole depth may be considered out of bounds, and for bit depth if the bit depth if greater than hole depth then the system would raise a flag, and every time this condition appears, the system may count it as a non-conformance event. It should be understood, however, that the above values are purely examples, and therefore these values should not be considered limiting as such.

In step 604, the system may provide data resolution for the rig sensor data received. Data resolution may be defined as the number of records streamed in a unit time. For example, if the number of data streamed within 24 hours is greater than 17280, then the data resolution is less than 5. In other words, the expected data resolution is 1 record in every 5 sec. It should be understood, however, that the above values are purely examples, and therefore these values should not be considered limiting as such. In step 606, the system may provide the expected number of records. For example, it may be expected for the system to have received a minimum of 17280 records in 24 hours. In step 608, the system may indicate the number of non-uniform events. For example, the system may indicate the streamed record as a non-uniform event if the record is received later than 5 sec or if there is an interval of greater than 5 sec between records. In step 610, the system may provide the number of illogical records by indicating the number of records, by channel, that are out of logic or pre-established boundaries. At step 612, the system may provide the number of streamed records by displaying the number of records streamed by a critical channel in 24 hours.

According to one example embodiment, the footage analysis process may include the calculation sequence for streamed data coming from rigs into a real time database. The surface parameters coming in real time from rig sensors may be defined and processed according the flow diagram illustrated in FIG. 5, for example. It should be noted, however, that the threshold by channel may be defined in order for the algorithm to be able to filter the data channels out of logic boundaries. The confidence on the results of these data quality analyses or interpretations may be directly associated to the quality of the data acquired. The scores generated by the system can help data managers to tackle data quality in one of two ways: (1) by communicating the quality scores via the official rigs evaluation channels in order to be used by decision makers to act accordingly, and (2) by providing drilling engineers with a systematic way for filtering poor quality data, and increasing the integrity of decisions made.

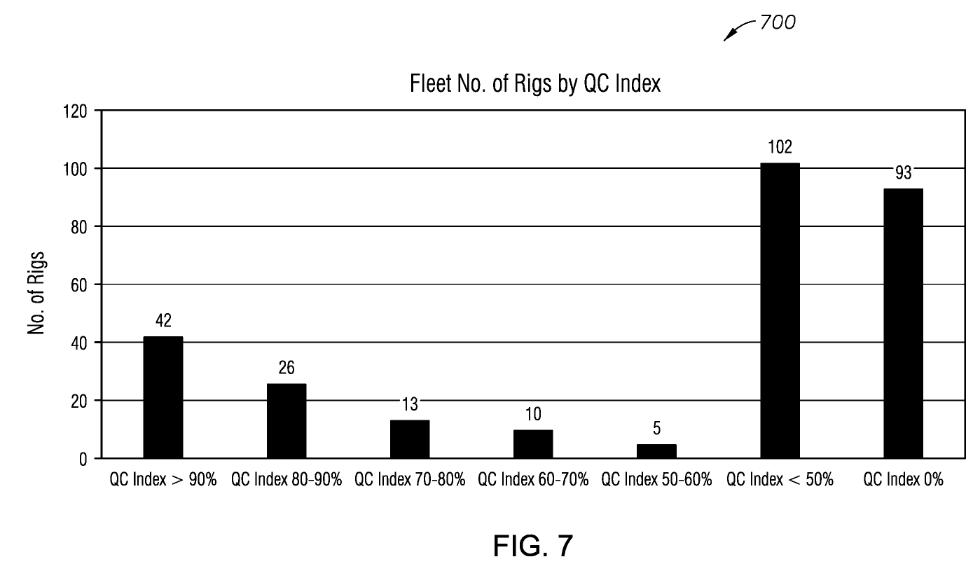

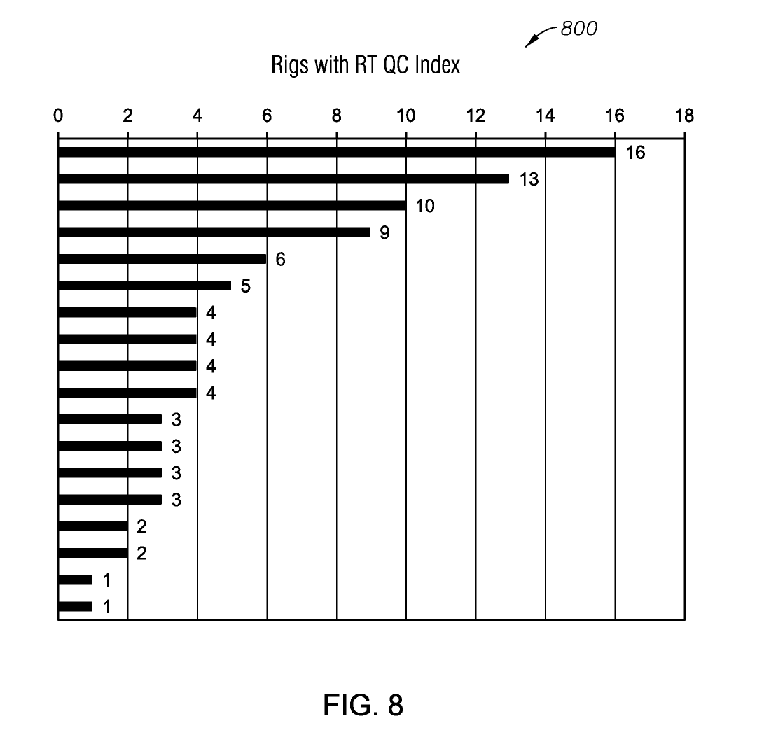

In one example embodiment, the system may generate one or more graphical illustrations 700 displaying data issues with the rig sensor data received. FIG. 7 illustrates an example chart 700 generated by the system, showing the number of rigs by their data quality index (QC index). For example, in this chart, there were 93 rigs with QC index of 0%, 102 rigs with QC index of less than 50%, 5 rigs with QC index between 50 and 60%, 10 rigs with QC index between 60 and 70%, 13 rigs with QC index between 70 and 80%, 26 rigs with QC index between 80 and 90%, and 42 rigs with QC index greater than 90%. Similarly, FIG. 8 illustrates an example chart 800 generated by the system 180, showing the number of rigs with a data quality index (QC index) of zero ‘0’ and their respective rig numbers, for example.

Example Computer Architecture

The following discussion is directed to various exemplary embodiments of the present invention, particularly as implemented into a situation-aware distributed hardware and software architecture in communication with one or more operating drilling rigs. However, it is contemplated that this invention may provide substantial benefits when implemented in systems according to other architectures, and that some or all of the benefits of this invention may be applicable in other applications. For example, while the embodiments of the invention may be described herein in connection with wells used for oil and gas exploration and production, the invention also is contemplated for use in connection with other wells, including, but not limited to, geothermal wells, disposal wells, injection wells, and many other types of wells. One skilled in the art will understand that the examples disclosed herein have broad application, and that the discussion of any particular embodiment is meant only to be exemplary of that embodiment, and not intended to suggest that the scope of the disclosure, including the claims, is limited to that embodiment.

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

By way of further background, the term “software agent” refers to a computer software program or object that is capable of acting in a somewhat autonomous manner to carry out one or more tasks on behalf of another program or object in the system. Software agents can also have one or more other attributes, including mobility among computers in a network, the ability to cooperate and collaborate with other agents in the system, adaptability, and also specificity of function (e.g., interface agents). Some software agents are sufficiently autonomous as to be able to instantiate themselves when appropriate, and also to terminate themselves upon completion of their task.

The term “expert system” refers to a software system that is designed to emulate a human expert, typically in solving a particular problem or accomplishing a particular task. Conventional expert systems commonly operate by creating a “knowledge base” that formalizes some of the information known by human experts in the applicable field, and by codifying some type of formalism by way the information in the knowledge base applicable to a particular situation can be gathered and actions determined. Some conventional expert systems are also capable of adaptation, or “learning”, from one situation to the next. Expert systems are commonly considered to be in the realm of “artificial intelligence.”

The term “knowledge base” refers to a specialized database for the computerized collection, organization, and retrieval of knowledge, for example in connection with an expert system. The term “rules engine” refers to a software component that executes one or more rules in a runtime environment providing among other functions, the ability to: register, define, classify, and manage all the rules, verify consistency of rules definitions, define the relationships among different rules, and relate some of these rules to other software components that are affected or need to enforce one or more of the rules. Conventional approaches to the “reasoning” applied by such a rules engine in performing these functions involve the use of inference rules, by way of which logical consequences can be inferred from a set of asserted facts or axioms. These inference rules are commonly specified by means of an ontology language, and often a description language. Many reasoners use first-order predicate logic to perform reasoning; inference commonly proceeds by forward chaining and backward chaining.

The present invention may be implemented into an expert computer hardware and software system, implemented and operating on multiple levels, to derive and apply specific tools at a drilling site from a common knowledge base, including, but not limited to, information from multiple drilling sites, production fields, drilling equipment, and drilling environments. At a highest level, a knowledge base is developed from attributes and measurements of prior and current wells, information regarding the subsurface of the production fields into which prior and current wells have been or are being drilled, lithology models for the subsurface at or near the drilling site, and the like. In this highest level, an inference engine drives formulations (in the form of rules, heuristics, calibrations, or a combination thereof) based on the knowledge base and on current data. An interface to human expert drilling administrators is provided for verification of these rules and heuristics. These formulations pertain to drilling states and drilling operations, as well as recommendations for the driller, and also include a trendologist function that manages incoming data based on the quality of that data, such management including the amount of processing and filtering to be applied to such data, as well as the reliability level of the data and of calculations therefrom.

The information integration environment is also operative to receive input from the driller via the host client system, and to act as a knowledge base server to forward those inputs and other results to the knowledge base and the inference engine, with verification or input from the drilling administrators as appropriate.

According to another aspect of the invention, the system develops a knowledge base from attributes and measurements of prior and current wells, and from information regarding the subsurface of the production fields into which prior and current wells have been or are being drilled. According to this aspect of the invention, the system self-organizes and validates historic, real time, and/or near real time depth or time based measurement data, including information pertaining to drilling dynamics, earth properties, drilling processes and driller reactions. This drilling knowledge base suggests solutions to problems based on feedback provided by human experts, learns from experience, represents knowledge, instantiates automated reasoning and argumentation for embodying best drilling practices.

In addition, while this invention is described in connection with a multiple level hardware and software architecture system, in combination with drilling equipment and human operators, it is contemplated that several portions and facets of this invention are separately and independently inventive and beneficial, whether implemented in this overall system environment or if implemented on a stand-alone basis or in other system architectures and environments. Those skilled in the art having reference to this specification are thus directed to consider this description in such a light.

Advantages of the example embodiments disclosed herein include that prior art methods are focused on troubleshooting rig sensors. The present systems and methods are focused on streamed data evaluation, thereby providing an index (0-100%) that reflects the quantity and quality of broadcasted rigs sensor readings. Prior art methods are specifically designed for one rig at a time data quality evaluation, while the present systems and methods can be utilized in multiple drilling rig fleets paralellely for data quality evaluation. Prior art methods require extensive pre-modelling and mathematical calculation time, while the present systems and methods integrate into one linear equation including elements that define the quality of rig sensors' broadcasted data. Due to their relatively simple design, the systems and methods of the present invention can be used virtually for any number of rigs, without requiring model pre-calibration.

The Specification, which includes the Summary, Brief Description of the Drawings and the Detailed Description, and the appended Claims refer to particular features (including process or method steps) of the disclosure. Those of skill in the art understand that the invention includes all possible combinations and uses of particular features described in the Specification. Those of skill in the art understand that the disclosure is not limited to or by the description of embodiments given in the Specification.

Those of skill in the art also understand that the terminology used for describing particular embodiments does not limit the scope or breadth of the disclosure. In interpreting the Specification and appended Claims, all terms should be interpreted in the broadest possible manner consistent with the context of each term. All technical and scientific terms used in the Specification and appended Claims have the same meaning as commonly understood by one of ordinary skill in the art to which this invention belongs unless defined otherwise.

As used in the Specification and appended Claims, the singular forms “a,” “an,” and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced. The verb “operatively connecting” and its conjugated forms means to complete any type of required junction, including electrical, mechanical or fluid, to form a connection between two or more previously non-joined objects. If a first component is operatively connected to a second component, the connection can occur either directly or through a common connector. “Optionally” and its various forms means that the subsequently described event or circumstance may or may not occur. The description includes instances where the event or circumstance occurs and instances where it does not occur.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

The systems and methods described herein, therefore, are well adapted to carry out the objects and attain the ends and advantages mentioned, as well as others inherent therein. While example embodiments of the system and method have been given for purposes of disclosure, numerous changes exist in the details of procedures for accomplishing the desired results. These and other similar modifications may readily suggest themselves to those skilled in the art, and are intended to be encompassed within the spirit of the system and method disclosed herein and the scope of the appended claims.

1. A system for monitoring sensor data quality in a drilling rig in real time, the system comprising:
one or more sensors operably connected to one or more components of the drilling rig, the one or more sensors configured to generate sensor data and transmit the sensor data to a control unit;
one or more processors operatively coupled to the control unit; and
a non-transitory computer-readable medium in communication with the one or more processors and having stored thereon a set of instructions that when executed cause the one or more processors to perform operations comprising:
receiving rig sensor data from the one or more components of the drilling rig;
determining a level of completeness of the sensor data by measuring a degree to which the sensor data comprises one or more desired parameters;
determining a level of uniformity of the sensor data by measuring a degree to which the sensor data is uniform over a predetermined period of time;
determining a level of sensibility of the sensor data by measuring a degree to which the sensor data falls within a set of predetermined logic boundaries;
determining a resolution of the sensor data by measuring a frequency with which the sensor data matches an expected sensor data;
determining a structure of the sensor data by measuring a degree to which the sensor data complies with a wellsite information transfer standard;
determining a format of the sensor data by measuring a degree to which the sensor data complies with a wellsite information transfer standard markup language;
applying a structured logic to the sensor data; and
determining a data quality index based on a weighted average of the level of completeness, the level of uniformity, the level of sensibility, the resolution, the structure, and the format of the sensor data.

2. The system of claim 1, wherein the instructions further cause the one or more processors to perform operations comprising:
receiving the data quality index from analysis of the rig sensor data; and
generating a graphical illustration displaying data issues in the received rig sensor data.

3. The system of claim 1, wherein the weighted average comprises 40% completeness, 20% uniformity, 20% sensibility, 10% resolution, 5% structure, and 5% format.

4. The system of claim 1, wherein the instructions further cause the one or more processors to perform operations comprising:
determining a number of rigs within a predetermined range of data quality indices; and
generating a graphical illustration displaying the number of rigs against the data quality indices.

5. The system of claim 1, wherein the one or more sensors comprise sensors that detect torque, revolutions per minute (RPM), weight on bit (WOB), hook load (HL), stand pipe pressure (SPP), pump pressure, hole depth, or bit depth.

6. The system of claim 1, wherein determining a level of completeness of the sensor data further comprises:
determining a number of streamed or received records and comparing the number to a number of expected records.

7. The system of claim 1, wherein determining a level of uniformity of the sensor data further comprises:
determining a number of records that are separated by a time interval greater than or less than a predetermined time interval.

8. The system of claim 1, wherein determining a level of sensibility of the sensor data further comprises:
determining a number of records that are outside of the predetermined logic boundaries.

9. The system of claim 1, wherein determining a resolution of the sensor data further comprises:
determining a number of records received or streamed within a predetermined period of time.

10. A method for monitoring sensor data quality in a drilling rig in real time, the method comprising:
receiving, by one or more processors coupled to a control unit in the drilling rig, rig sensor data from one or more components of the drilling rig;
determining a level of completeness of the sensor data by measuring a degree to which the sensor data comprises one or more desired parameters;
determining a level of uniformity of the sensor data by measuring a degree to which the sensor data is uniform over a predetermined period of time;
determining a level of sensibility of the sensor data by measuring a degree to which the sensor data falls within a set of predetermined logic boundaries;
determining a resolution of the sensor data by measuring a frequency with which the sensor data matches an expected sensor data;
determining a structure of the sensor data by measuring a degree to which the sensor data complies with a wellsite information transfer standard;
determining a format of the sensor data by measuring a degree to which the sensor data complies with a wellsite information transfer standard markup language;
applying a structured logic to the sensor data; and
determining a data quality index based on a weighted average of the level of completeness, the level of uniformity, the level of sensibility, the resolution, the structure, and the format of the sensor data.

11. The method of claim 10, further comprising:
receiving, by the one or more processors, the data quality index from analysis of the rig sensor data; and
generating a graphical illustration displaying data issues in the received rig sensor data.

12. A non-transitory computer-readable medium including instructions stored thereon, which when executed by one or more processors operatively coupled to the computer-readable medium, cause the one or more processors to perform operations comprising:
receiving rig sensor data from one or more components of a drilling rig;
determining a level of completeness of sensor data acquired from a control unit of an oil rig by measuring a degree to which the sensor data comprises one or more desired parameters;
determining a level of uniformity of the sensor data by measuring a degree to which the sensor data is uniform over a predetermined period of time;
determining a level of sensibility of the sensor data by measuring a degree to which the sensor data falls within a set of predetermined logic boundaries;
determining a resolution of the sensor data by measuring a frequency with which the sensor data matches an expected sensor data;
determining a structure of the sensor data by measuring a degree to which the sensor data complies with a wellsite information transfer standard;
determining a format of the sensor data by measuring a degree to which the sensor data complies with a wellsite information transfer standard markup language;
applying a structured logic to the sensor data; and
determining a data quality index based on a weighted average of the level of completeness, the level of uniformity, the level of sensibility, the resolution, the structure, and the format of the sensor data.

13. The medium of claim 12, wherein the instructions further cause the one or more processors to perform operations comprising:
receiving the data quality index from analysis of the rig sensor data; and
generating a graphical illustration displaying data issues in the received rig sensor data.

14. The medium of claim 12, wherein the weighted average comprises 40% completeness, 20% uniformity, 20% sensibility, 10% resolution, 5% structure, and 5% format.

15. The medium of claim 12, wherein the instructions further cause the one or more processors to perform operations comprising:
determining a number of rigs within a predetermined range of data quality indices; and
generating a graphical illustration displaying the number of rigs against the data quality indices.

16. The medium of claim 12, wherein the one or more sensors comprise sensors that detect torque, revolutions per minute (RPM), weight on bit (WOB), hook load (HL), stand pipe pressure (SPP), pump pressure, hole depth, or bit depth.

17. The medium of claim 12, wherein determining a level of completeness of the sensor data further comprises:
determining a number of streamed or received records and comparing the number to a number of expected records.

18. The medium of claim 12, wherein determining a level of uniformity of the sensor data further comprises:
determining a number of records that are separated by a time interval greater than or less than a predetermined time interval.

19. The medium of claim 12, wherein determining a level of sensibility of the sensor data further comprises:
determining a number of records that are outside of the predetermined logic boundaries.

20. The medium of claim 12, wherein determining a resolution of the sensor data further comprises:
determining a number of records received or streamed within a predetermined period of time.
